(19) United States
(12) Patent Application Publication
(10) Pub. No.: US 2003/0107029 A1
(43) Pub. Date: Jun. 12, 2003

(54) Marine heave compensating device and winch drive

(76) Inventors: Kenneth Hanson, Barnsley S75 4EF (GB); Lee Hanson, North Yorkshire Y012 6QG (GB); Mark Andrew Thomas Bentley, Derbyshire SK17 8SU (GB)

Correspondence Address: OSTROLENK FABER GERB & SOFFEN, 1180 AVENUE OF THE AMERICAS, NEW YORK, NY, 100368403

(21) Appl. No.: 10/149,338

(22) PCT Filed: Dec. 8, 2000
(86) PCT No.: PCT/GB00/04687

(30) Foreign Application Priority Data
Dec. 10, 1999 (GB) 9929102.3

(51) Int. Cl. B66D 1/48; B66D 1/12

(52) U.S. Cl. 254/362; 254/267; 254/900

(57) ABSTRACT

A winch for use in a heave compensation system has a winch drum (42) driven by an AC asynchronous motor (50) via a gearbox (52). The motor (50) is controlled by a variable speed control (58) as a function of heave speed. The motor (50) and its drive train, and the winch (42), are chosen to have low inertia. The winch pays out and reels in to compensate for heave substantially instantaneously, without the need for prediction of wave patterns.

This invention relates to reeling and winch systems, and in particular to systems for use in maritime applications.

Typically, a maritime reeling system is mounted on a vessel to control a cable from which an article is suspended in the water from the vessel, either over the side or through a moonpool or the like. The vessel may be a ship, semi-submersible rig, oil platform or other floating vessel. The suspended article may be, for example, drilling equipment, test equipment, or an inspection chamber. In many applications of this nature, it is necessary for the suspended article to be held at a substantially fixed location, for instance to avoid damage to drilling equipment. In other situations it is important to maintain constant tension but not necessarily support a load, for example in handling tethers or umbilicals for remotely operated vehicles (ROVs) and diving bells or the like. The former type of situation is commonly called “winching” and the latter “reeling”, but the term “reeling” is used herein to encompass both.

In all of these situations, wave motion will cause the vessel to move up and down (“heave”), so that arrangements have been used to provide heave compensation in reeling systems.

Many prior art heave compensation systems use pneumatic or hydraulic control systems to drive a winch, there being an arrangement for recording the recent history of heave movement to provide a prediction of future movement, thereby allowing the winch to be controlled to pay out or reel in cable in an attempt to compensate future heave. However, such systems have limited usefulness owing to the non-uniformity of real life wave patterns. Also, the compressibility of the working fluid in pneumatic and hydraulic systems inevitably introduces time lags.

It is also known to use electrically powered winches controlled by electric systems. Hitherto, such winches have mostly been powered by DC motors because of the speed/torque characteristics of such motors, particularly the provision of high torque at low speed, but the use of AC motors is also known.

The commonest system is to use a single DC motor which is controlled to follow a desired torque. This leads to a phase lag between torque and speed, and hence between the input command signal and speed, which phase lag can only be accommodated by the use of predictive controls.

It is also known to use two DC motors operating via a common mechanical drive system. One of the motors is a low speed, high torque motor and the other a low torque, high speed motor. The first motor is used for the main raising and lowering functions, and the second motor to provide relatively rapid heave compensation motion. However, this approach substantially increases weight, bulk and complexity.

In prior art heave compensation systems using AC motors, the motor has been controlled in terms of torque and, as with systems using a single DC motor, this leads to a phase lag between the input control signal and the speed of the motor.

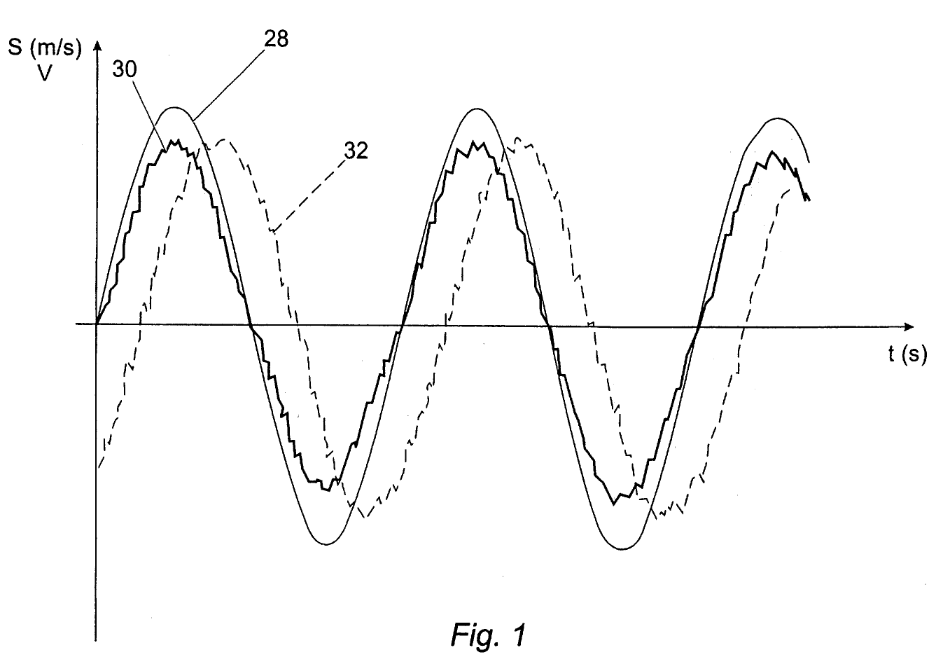

This may be further explained with reference to FIG. 1, which illustrates the response of a prior art system using a winch driven by a high torque, low speed electric motor, either DC or AC. Since such a motor has low speed and low acceleration, the control input 28 is a torque demand signal. The motor torque 30 follows the control input closely but, because of the inherent characteristics of the motor, is rough (jerky). The motor speed 32 then follows as a function of the motor torque 30, with a phase lag, and also with a rough form. There is thus a phase lag in the heave compensation itself, and the jerkiness of the motion is detrimental to the fatigue life of the system.

Moreover, in prior art systems whether using hydraulic, DC or AC motors, the motor has been chosen to have a maximum torque output which is equal to the maximum torque required by the worst anticipated sea state, that is a motor which is capable of providing such torque on a continuous basis. This leads to the use of a motor having a high inertia, which in turn increases the response time of the winch.

U.S. Pat. No. 4,547,857 is one example of a predictive heave compensation system using either a hydraulic or an electric winch motor.

U.S. Pat. No. 4,434,972 discloses a hydraulic hoisting arrangement in which a winch drum is driven through a gear train and freewheel arrangement by two hydraulic motors: a high-torque, low-speed motor for hoisting, and a low-torque, high-speed motor for compensating.

These and other prior art proposals suffer from system time lags which introduce a phase shift between the sea surface waveform and the motion of the hoisting drum.

The present invention provides a dynamic winch for use in a heave compensation system, comprising a winch drum and an electric motor connected to rotate the winch drum; and in which the electric motor is an AC motor controlled by a variable speed drive.

From another aspect, the invention provides a maritime reeling system comprising a winch as defined in the preceding paragraph mounted on a marine structure, and a sensor arranged to sense a parameter associated with heave in the vicinity of said structure, said sensor being connected to supply an input signal to said variable speed drive.

An embodiment of the invention will now be described, by way of example only, with reference to the drawings, in which:

FIG. 1 illustrates the system response in a typical prior art heave compensation system, as discussed above;

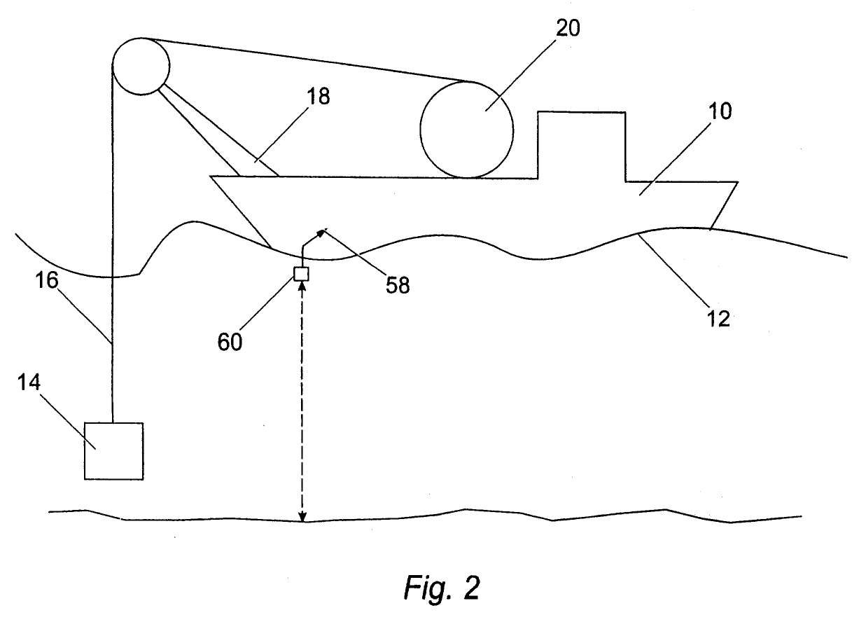

FIG. 2 is a schematic side view of a vessel from which an item is suspended by a winch system;

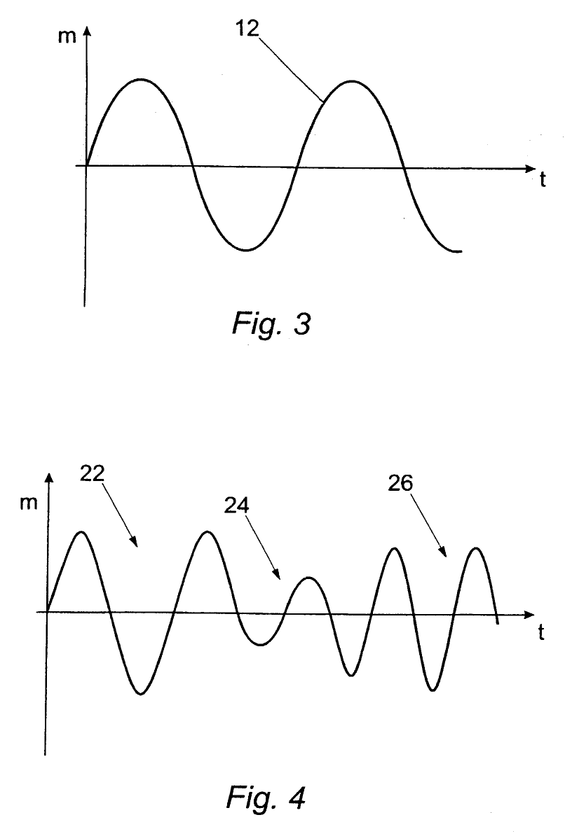

FIG. 3 schematically shows idealised wave motion of the surface of the sea;

FIG. 4 shows typical actual sea conditions;

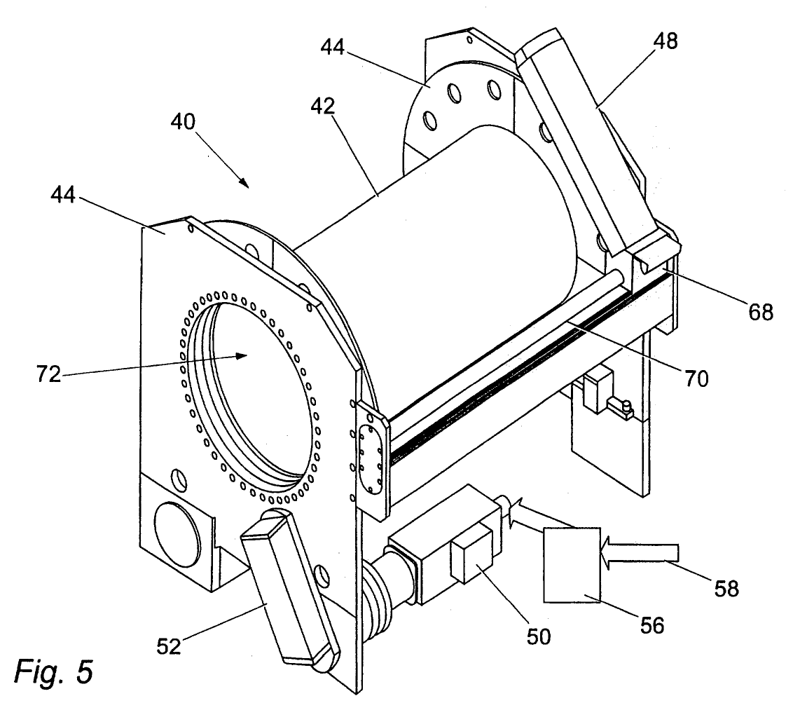

FIG. 5 illustrates one system embodying the present invention;

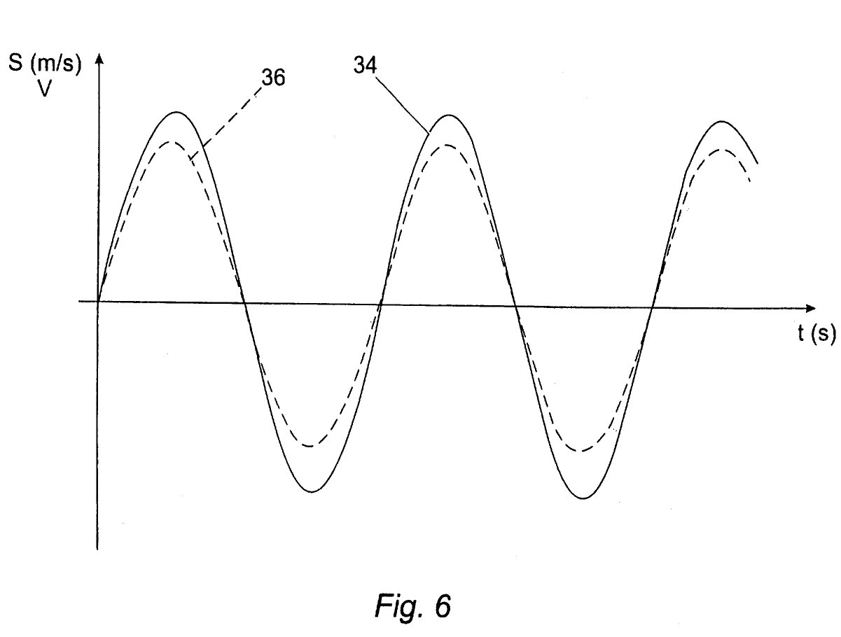

FIG. 6 illustrates the system response of the system of FIG. 5; and

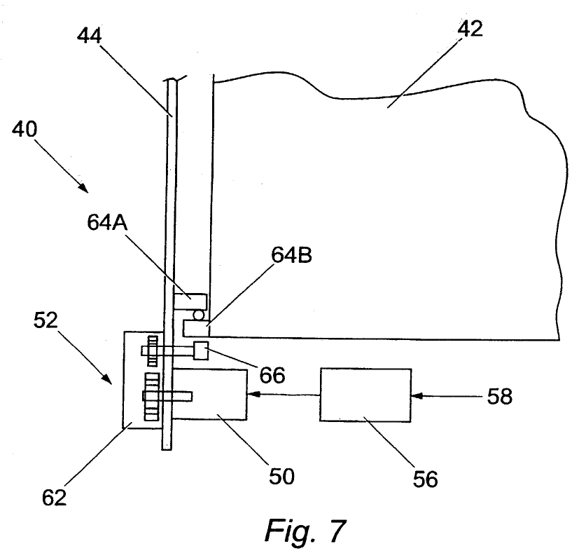

FIG. 7 is a schematic diagram of the drive arrangement for the system of FIG. 5.

FIG. 2 shows schematically a vessel 10 on the sea surface 12 and supporting a load 14 from a cable 16 by means of a crane, derrick or overboarding sheave arrangement 18, controlled by a reeling system (hereinafter termed a “reeler”) 20. The reeler is able to reel in or pay out the cable 16 in order to raise or lower the load relative to the vessel 10.

In particular, the reeler 20 is intended for use with an umbilical, for deploying, retrieving and storing the umbilical in a manner which protects the umbilical against damage. Umbilicals may be complex and expensive items, incorporating services such as electrical, hydraulic or pneumatic power supplies, signal cables, fibre optics and the like, and therefore vulnerable to expensive damage if not handled appropriately.

The sea surface 12 will normally have waves moving across it, causing the vessel 10 to heave as the waves pass beneath it. FIG. 3 shows an idealised profile of the surface 12, which is sinusoidal, as assumed for example in standard works such as Lloyds directory of Shipping. This Directory provides reference data concerning the amplitude and frequency of waves expected in different sea states and in different sea. areas. In reality, the motion of the sea surface will rarely be as uniform as suggested by FIG. 3 and may exhibit variations such as those shown in FIG. 4, in which the amplitude and frequency of the waves each varies with time and position. Thus, the wave motion may be relatively large in amplitude and low in frequency, as indicated generally at 22; or lower in amplitude but still lower in frequency as indicated at 24; or high in amplitude and high in frequency as indicated at 26. Many other sea states may be encountered. In practice the variations encountered will depend on the sea area being considered, weather conditions, tidal conditions, and the like, resulting in the vessel moving in a combination of heave, pitch, yaw and roll.

The present invention seeks to track the heave substantially without phase shift, thus avoiding the need for predictive techniques.

FIG. 5 illustrates a maritime reeling system in accordance with the present invention. The system 40 has a drum 42 rotatably mounted in side cheeks 44 by appropriate bearings. The drum 42 will carry a cable (not shown) for paying out or reeling in by rotation of the drum 42 in an appropriate sense. Cable guides 48 are provided, as will be described in more detail below, to assist in providing accurate spooling of the cable onto the drum 42, to minimise damage to the cable. Power to turn the drum 42 is provided by a motor 50 coupled with the drum by a drive train indicated generally at 52 at one end of the drum 42. The drive train 52 may incorporate gearboxes and the like.

The motor 50 is an AC motor, of a type well known in itself. The requirements for the motor in the present system are discussed in more detail below. The motor 50 receives power from a control circuit 56 which is preferably remote from the motor 50. The control circuit 56 is arranged, as will be discussed in more detail below, to supply power to the motor 50 in such a manner that the motor speed follows an input signal 58. The input signal 58 is preferably representative of the speed of the load 14 relative to a fixed frame of reference (the sea bed), but could alternatively be a function of the acceleration of the load, the absolute position of the load, or the tension in the cable 16.

One suitable arrangement, indicated in FIG. 1, is a sensor 60 (for example, an ultrasonic sensor) located on the vessel 12 to measure the instantaneous distance between the vessel and the sea bed, from which the instantaneous speed may be derived.

In the event of the sea surface being entirely flat, which is most uncommon, no heave compensation will be required. The input 58 will indicate zero load speed, and consequently the controller 56 will provide zero input to the motor 50. Once the sea surface 12 begins to move, the input 58 will indicate speed of the load 14 relative to the sea bed, and the control circuit 56 will immediately respond by instructing the motor 50 to turn in the appropriate direction to cause the system 40 to pay out or reel in cable in order to negate the heave, the motor being controlled to attain a target speed equivalent to the instantaneous speed of the load.

The nature of the motor 50 and the fact that it is speed driven allows the control circuit 56 to respond directly to any change in load speed or position being sensed. That is to say, the drum 42 can start turning almost instantly as soon as any change in load speed or position is sensed. Because of the speed of response, and by arranging to provide adequate power output from the motor 50 and low inertia within the system, the cable can be paid out or reeled in sufficiently rapidly to track the heave, so that the load 14 can be retained at an accurate, fixed position.

This speed of response contrasts markedly with the response characteristics of a predictive system using hydraulics, pneumatics or a DC electric motor, and allows the system to track the instantaneous position without any requirement for prediction, and therefore providing the ability to respond immediately to any changes in wave amplitude, frequency or shape. The problems associated with a predictive system are thereby substantially avoided. The heave compensation provided by a system according to the present invention can remain in phase with the sea motion being experienced, at all times, by virtue of the substantially instantaneous response achieved by electronic control in conjunction with an AC motor and low inertia components.

FIG. 6 shows the system response of the system of FIG. 5. The input signal 34 is a speed signal, and the motor is driven to have its speed 36 follow the input signal 34. The motor speed 36 is smooth and substantially in phase with the input signal 34. The winch will accelerate and decelerate smoothly and always be in phase with the motion input. The motion torque curves will always be out of phase with the speed curve.

An AC motor will have a minimum rotation speed below which operation is not possible or is unpredictable, so that it is preferable for the control circuit 56 not to instruct motor movement when the load position is changing at a rate lower than a predetermined threshold rate. However, when changing at a very low rate, tension on the cable will be changing only very slowly and thus not dangerously for the integrity of the cable. Applying a threshold in this manner will have the effect of damping the peaks of the wave motion by not responding to the wave shape at or close to the peak, but it is envisaged that by appropriate design or choice of motor this damping can be reduced to an extent at which cable damage is avoided. The use of the threshold has the advantage of preventing the system hunting in the event of small changes being experienced.

The drive train to the drum 42 is shown in more detail, schematically, in FIG. 7. As has been described, the motor 50 is controlled by the control circuit 56, which is an electrical variable speed drive unit. Suitable variable speed drive units include the “Midimaster” vector drive by Siemens and the “ALSPA MV3000” by Alstom

The motor 50 drives a gear box 62 mounted on one side cheek 44, which in turn drives the outer ring 64B of a ball race 64, by means of a pinion 66. The outer ring 64B is secured to the drum 42 and co-operates with an inner ring 64A secured to the side cheek 44, so that operation of the motor 50, through the gear box 62 and pinion 66, will cause the drum 42 to rotate within the stationary side cheeks 44.

In the interests of the speed of response, the design of the drive train should be chosen to minimise delays in the response of the system, particularly from inertia and friction.

The control circuit 56 can be substantially wholly electrical or electronic, receiving electrical signals from sensors such as 60, so as to minimise delays in the system.

The motor 50 should be selected for low inertial properties. Examples are commercially available, such as the flux vector drive motors manufactured by Siemendori or by Siemens. Similarly, the design of gear box 62 should be chosen for low inertial properties and could be a Cyclo gear box manufactured by Sumitomo, or a compound gearbox type. The components of the ball race 64 can also be designed for minimally increasing the moment of inertia of the drum 42, by appropriate choice of materials, sizes and the like. Reduction of moments of inertia within the system reduces the overall torque requirement of the motor 50, thus allowing a low inertia motor to be used, with further improvement in the response time of the system. The drive train can also be designed to reduce backlash, particularly in the gear box 62.

The choice of the motor 50 will be governed by the following considerations. In an AC motor the speed and torque are linked. Maximum torque can be developed at any speed up to a certain maximum (the synchronous speed) determined by the physical characteristics of the machine. Above the synchronous speed, the torque available will decrease. If the synchronous speed is high, the motor must be mechanically capable of carrying the maximum torque at high speed, and this will have an influence on the inertia of the motor and thus on the speed of response. With a low synchronous speed (typically about 1500 rev/min) the inertia of the motor will be low and its response time fast.

If the motor is chosen to provide a maximum power determined by the worst anticipated heave (worst sea state), the motor will be mechanically large with a high inertia and poor response time. However, since the sea waves are approximately sinusoidal, the maximum power is required only for a fraction of the wave period. In the remainder of the period a lower power is required. We have established that in the sea conditions of interest the required power is lower than 60% of the worst maximum power (worst sea state) for 80% of the wave period. Therefore, in preferred embodiments of the present invention the winch motor is chosen to have an intermittent power rating which can handle the worst sea state acceleration and power requirement for 20% of the cycle (typically 60 s in a cycle of 300 s), and to be capable of handling 60% of the worst sea state power requirement for the remainder of the time.

The worst sea state imposes a requirement for very high acceleration during part of the wave cycle. In the preferred forms of the invention, a motor of low synchronous speed is used, Consequently, during parts of the wave cycle the motor will operate above its synchronous speed and torque will tend to fall. When operating above synchronous speed, the motor can produce the required torque by increasing its power, which is a function of speed and torque, above its continuous rated power.

Therefore, the preferred motor is chosen to be capable of producing 150% of its maximum rated continuous power for up to 60 s, and of producing 90% of its maximum rated continuous power for 240 s thereafter. That is, the preferred motor has a maximum continuous rated power equal to the substantial part of the worst sea state power and acceleration requirement. Other combinations of intermittent and continuous ratings will be possible within the general concept of using a motor with a continuous rating less than the worst sea state maximum power and acceleration requirement. In this way a motor of minimum inertia is provided. Any heave compensation being effected in the manner described above may be used to maintain the load 14 in a fixed position, or may be superposed on drum rotation required for a given deployment or retrieval of the load 14, so that deployment or retrieval can be a steady operation even with heave of the vessel 10.

The reeler 20 is capable of suspending a load on the surface of the sea without producing any unnecessary strain on the umbilical used for deploying the suspended load, because the swell on the sea is substantially instantaneously compensated by the arrangements described. Synchronising the umbilical length to the sea motion in this way is possible even if the vessel 10 is being driven in the horizontal plane.

Referring again to FIG. 5, the winch is provided with a level wind mechanism in which cable being paid out or reeled in passes through guides 48 in the form of elongate parallel rollers and other devices mounted at one end on a shuttle 68. The shuttle 68 is movable along a threaded shaft 70 parallel to the axis of the drum 42, the shaft 70 being rotated by an electric motor (not shown) to drive the shuttle 68 along the shaft 70. The motor is preferably controlled by the control circuit 56 (or another circuit communicating with the circuit 56) such that movement of the/guides 48 along the drum 42 is synchronised with rotation of the drum 42 to achieve an accurate helical laying of the cable 16 on the drum 42. The same inertia requirement and acceleration apply to the level wind assembly.

The control arrangements for rotating the shaft 70 operate to match the speed of rotation of the drum 42 with the speed of movement of the guides 48 along the shaft 70, at a fixed ratio dependent on the diameter of the umbilical being reeled. If a different diameter umbilical is to be used, then a new ratio and speed can be selected, for which reason it is convenient for the shaft 70 to be controlled by an electronic control system, electronic gearbox, or the like, to allow ready adjustment of the ration being used. In this way, the co-ordination of the two motor speeds can be highly sophisticated, such as to change at different points along the length of the umbilical in the event that the umbilical diameter is not constant along its length. The position or speed of the drum 42 can be provided for control of the shaft 70 by encoders at an appropriate location within the drive train to the drum 42.

Accurate helical laying of the umbilical on the drum 42 is important in preventing damage and wear of the umbilical, particularly by chafing or abrasion. Consequently, the guides 48 must be positioned with a response time fast enough to match the response times with which the drum 42 can be rotated, and this is facilitated by the use of electronic control of the shaft 70 and by the choice of low inertia components.

It is apparent from FIG. 5 that the arrangements for driving the drum 42 are located outside the drum, so that the centre 72 of the drum can be open and substantially unobstructed. This provides a number of advantages. First, the open drum centre provides a location for couplings to the end of the cable 16, such as for power transfer, fibre optic connections, or the like. Secondly, the open nature of the centre 72 provides for air or water cooling of the drum 42 from within. This can be important in practice, particularly when the cable 16 is conducting electrical power to the load 14. Power being conducted along the cable 16 will tend to give rise to inductive heating effects due to the coiled nature of the cable 16 around the drum 42, which can be offset by cooling via the centre 72.

It is envisaged that when the cable is being paid out resistive braking external to the motor 50 or elsewhere in the drive train can be used to control drum motion, and also to generate electrical power which can be provided to the vessel 10 to reduce the mean power requirement of the winch arrangement or for other purposes. In addition, the magnetic nature of the motor allows the drum position to be located almost instantaneously when stopping, without any bounce.

The load illustrated in FIG. 1 is an item such as a piece of equipment hanging from the cable 16. Alternatively, the load could be the weight of a cable being laid on the seabed, with the heave compensation arrangement used for shock absorbing. As another alternative, the load could be the tension in a mooring cable, towing cable or the like. While the vessel 10 is illustrated as a ship, it will be apparent that similar problems are experienced with semi-submersible oil rigs and other floating structures, and in transferring loads between fixed structures (such as seabed-located oil rigs) and floating structures (such as supply vessels). In one application envisaged for the invention, heave compensation would be provided for a tanker loading from a subsea oil well installation.

The apparatus described above may be modified without departing from the scope of the present invention as defined in the appended claims. More than one sensor may be used for detecting the motion to be compensated. For instance, sensors could be provided on the load, on the vessel, on the sea surface, or on the seabed.

1. A dynamic winch for use in a heave compensation system, comprising a winch drum and an electric motor connected to rotate the winch drum; in which the electric motor is an ac motor controlled by a variable speed drive; characterised in that the motor is selected in relation to the maximum anticipated sea state acceleration and power requirement to have a continuous power rating less than the maximum sea state required power.

2. A winch according to claim 1, in which the motor has a sufficiently high speed and acceleration and the winch has a sufficiently low inertia to follow a speed signal input substantially instantaneously.

3. A winch according to claim 1 or claim 2, in which the motor is a flux vector drive motor.

4. A winch according to any preceding claim, in which the motor is selected to be capable of producing the maximum sea state required power for a fraction of the anticipated wave sinusoidal cycle.

5. A winch according to claim 4, in which the motor is selected to be capable of producing the maximum sea state required power for 20% of the wave cycle and 60% of that power for the remainder of the wave cycle when the motor is running past synchronous speed.

6. A winch according to claim 5, in which the motor can produce 150% of its continuous rated power for 20 s in a 300 s period.

7. A winch according to any preceding claim, in which the winch drum is mounted for rotation between stationary cheeks, and the motor drives the drum via a gear train secured to the exterior of one of said cheeks.

8. A winch according to claim 7, in which the winch drum has an open centre.

9. A winch according to any preceding claim, including a level wind mechanism driven by a second electric motor synchronised with the motor which drives the winch drum.

10. A maritime reeling system comprising a winch in accordance with any preceding claim mounted on a marine structure, and a sensor arranged to sense a parameter associated with heave in the vicinity-of said structure, said sensor being connected to supply an input signal to said variable speed drive.

11. A system according to claim 10, in which said parameter is the vertical speed of the water surface or of an object floating on it.

12. A system according to claim 11, in which said object is the marine structure on which the winch is mounted.

13. A system according to claim 11, in which said object is the winch load.
